(19) United States
(12) Patent Application Publication
(10) Pub. No.: US 2007/0094701 A1
(43) Pub. Date: Apr. 26, 2007

(54) Method to store and distribute full length movies on a portable non-volatile solid-state storage device

(76) Inventor: Michael Lee Kawase, Vancouver (CA)

Correspondence Address: Michael Lee Kawase, #6138 - 530 Adelaide Street West, Toronto, ON, M5V 2K7, CA

(21) Appl. No.: 11/255,238

(22) Filed: Oct. 21, 2005

(51) Int. Cl. H04N 7/173; H04N 7/16

(52) U.S. Cl. 725/134; 725/142; 725/89

(57) ABSTRACT

A new method for storing and distributing full-length movies on a portable non-volatile solid-state storage device. Digitized compressed signals containing audiovisual components of a movie are sent to a portable non-volatile solid-state storage device and stored in a permanent or non-permanent state. The customer can use the portable non-volatile solid-state storage device with a compatible portable non-volatile solid-state storage device reader to view the movie on a television set or a compatible computer system.

### CROSS-REFERENCE TO RELATED APPLICATIONS

Not Applicable

### FIELD OF THE INVENTION

This invention relates to the method to store and distribute full-length movies stored on a portable non-volatile solid-state storage device.

### BACKGROUND OF THE INVENTION

The present invention relates to a method for the distribution of movies to a customer using a portable non-volatile solid-state storage device. The movies on the portable non-volatile solid-state storage device will be available in a read-only, permanent or read-write-erase, temporary format. All the movies will be supplied electronically to the portable non-volatile solid-state storage device from a Movie Database Computer System. The movies can be viewed on the customer's television set or computer system with a compatible portable non-volatile solid-state storage device reader.

At the present time, commercial movies selected by a customer for home viewing are conventionally provided on cassette tapes in electromagnetic form or on digital videodisc (DVD) in digital form. The tape or DVD is often rented, in a video rental store, for a short period of time or bought from a retail store then taken to the customer's home and played there on a mechanical video cassette player or DVD player, electronically connected to the customer's television. In most cases, the rented tape or DVD must be returned to the video rental store on the due date or a late penalty fee will be charged.

It is the object of the present invention to provide a system which will replace the need for selecting movies on conventional video cassettes and DVD and replace it with the use of a small, portable, re-useable, durable, solid-state memory devices (such as a compact flash card or Universal Serial Bus memory device) that can be viewed using a non-mechanical solid-state reader device.

It is further the object of the present invention to provide a new method to store and distribute movies, selected by the customer, from a Movie Database Computer System (MDCS), direct to the customer's portable non-volatile solid-state storage device.

The customer's portable non-volatile solid-state storage device can display the movie to a television set or computer device using a compatible storage device reader. As flash memory storage devices become less costly, our object of the present invention can utilize the flash memory to provide customers with a more advanced and improved alternative to the conventional videotape and DVD. Both video and DVD have a limited life span because of worn tape and surface scratches, respectively. The customers will also have instant access to a large database of movies, in any language, anytime, from virtually any location, in a more convenient, portable and economical way.

### SUMMARY OF THE INVENTION

In accordance with the present invention there is provided a method for distributing movies to be viewed on a customer's television set or computer system. The method comprises the steps of digitizing and compressing data containing audiovisual data corresponding to the entire movie, storing the Movie Data File (MDF) to a Movie Database Computer System (MDCS) and distributing the Move Data File (MDF) to a portable non-volatile solid-state storage device. The customer can select movies from the Movie Database Computer System and retrieve the Movie Data File (MDF) and store the file to a portable non-volatile solid-state storage device.

### BACKGROUND OF INVENTION—OBJECTS AND ADVANTAGES

Accordingly, besides the objects and advantages of the portable non-volatile solid-state storage device described in the above background description, several objects and advantages of the present invention are:
(a) A flash memory storage device has no loss of data integrity for over 100 years;
(b) A flash memory storage device has the capacity to be written and read over one million times;
(c) A flash memory storage device has an operating shock rating of 2,000 Gs, which is equivalent to a 10-foot drop;
(d) A flash memory storage device does not require a battery to retain data indefinitely;
(e) A flash memory storage device weighs a half-ounce and is the size of a matchbook or smaller;
(f) A flash memory storage device data is protected by a built-in dynamic defect management and error correction technology;
(g) A flash memory storage device provides low cost storage solution for all capacities;
(h) A Movie Data File (MDF) is secure;
(i) A Movie Data File (MDF) can be easily stored to compatible storage devices;
(j) A Movie Data File (MDF) can by transferred across networks or the Internet;
(k) A Movie Data File (MDF) can be converted into various video formats;
(o) A Movie Data File (MDF) can be in a foreign language;
(p) A Movie Data File (MDF) is compressed to minimized required space;
(o) A Movie Data File (MDF) is compatible with personal video playing devices;
(h) A movie database computer system (MDCS) can provide a cost effective method to deliver movies to customers, since no physical delivery of the movie is necessary;
(i) A movie database computer system (MDCS) can reduce the cost of retail space, needed by a typical video store, through use of multiple computer terminals connected to the database, therefore lessening the need for large video and DVD wall display areas;
(j) A movie database computer system (MDCS) can allow a customer to access movie reviews, viewer recommendations as well as short trailers or samples that can be viewed before renting or purchasing the movie;
(k) A movie database computer system (MDCS) can be available to the customer 24 hours per day, 7 days per week, anywhere in the world and in any language;
(l) A movie database computer system (MDCS) can store foreign movies in different formats depending upon which system is required per each geographical location, such as NTSC, PAL and SECAM;
(m) A movie database computer system (MDCS) can be networked together through the use of a Local Area Network (LAN), Wide Area Network (WAN), or high-speed Internet connection to allow for easy transfer of the Movie Data Files (MDF) between systems and customers;
(n) A Movie Data File Player (MDFP) is small, portable and light;
(o) A Movie Data File Player (MDFP) is compatible with a most flash memory storage devices;
(p) A Movie Data File Player (MDFP) is upgradeable as newer technologies are developed;
(q) A Movie Data File Player (MDFP) can be utilized in many areas, such as the automotive and aerospace industry;
(q) A Movie Data File Player (MDFP) can be implemented into existing portable devices;

Further objects and advantages are to provide a method of movie distribution, which can be used easily and conveniently to allow any person with a compatible non-volatile solid-state storage device to use our system to acquire full-length movies, as well as be expandable as other digital file formats become available. Still further objects and advantages will become apparent from a consideration of the ensuing description and drawings.

### BRIEF DESCRIPTION OF THE DRAWINGS

These and other objects and advantages of the invention will become apparent upon reading the following detailed description and upon referring to the drawings in which:

FIG. 1 constitutes a flow chart illustrating the manner in which movies are prepared for storage and stored on a Movie Database Computer System;

FIG. 2 is a diagram of the method of and apparatus for distributing a movie to a customer to be stored on a portable non-volatile solid-state storage device; and

FIG. 3 is a diagram of the method of and apparatus for viewing a movie on the customer's television set or computer system, in accordance with the present invention.

While the invention will be described in conjunction with an example method, it will be understood that it is not intended to limit the invention to such a method. On the contrary, it is intended to cover all alternatives, modifications and equivalents as may be included within the spirit and scope of the invention as defined by the appended claims.

### DRAWINGS

### Reference Numerals

| | | | |
|---|---|---|---|
| 2 | Movie in DVD format | 4 | Movie in Film or Video format |
| 6 | Video Digitizer | 8 | Audio Digitizer |
| 10 | Movie Compression Computer System | 12 | Movie Data File |
| 14 | Movie Database Computer System | 16 | Remote Movie Database Computer |
| | | | System |
| 18 | Kiosk Movie Database Computer System | 20 | Online Movie Database Computer |
| | | | System |
| 22 | Security Encryption System | 24 | Portable Non-Volatile Solid-State |
| | | | Storage Device |
| 26 | Portable Non-Volatile Solid-State Storage | 28 | Movie Data File Decryption System |
| | Device Reader | | |
| 30 | Movie Data File Output to Display | | |

### DETAILED DESCRIPTION OF THE INVENTION

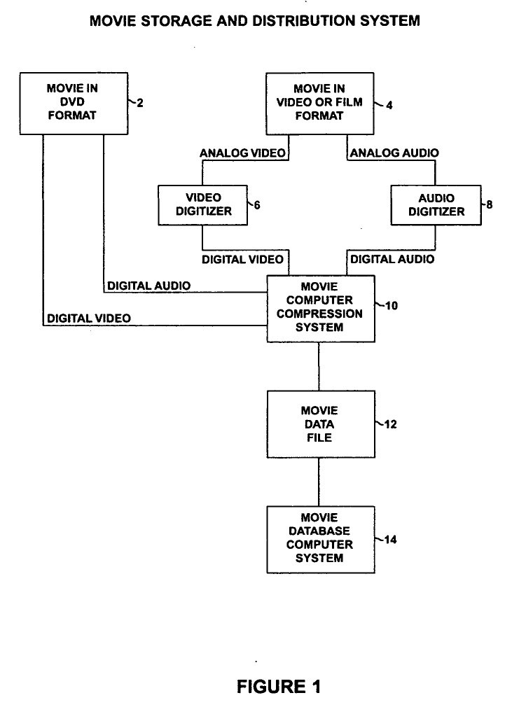

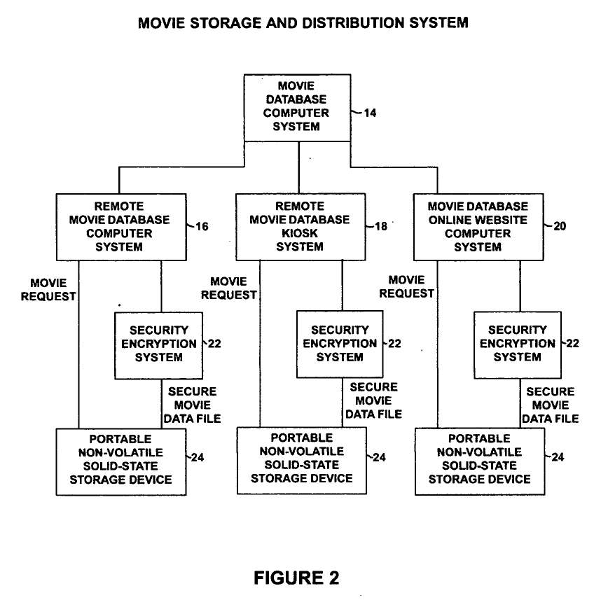

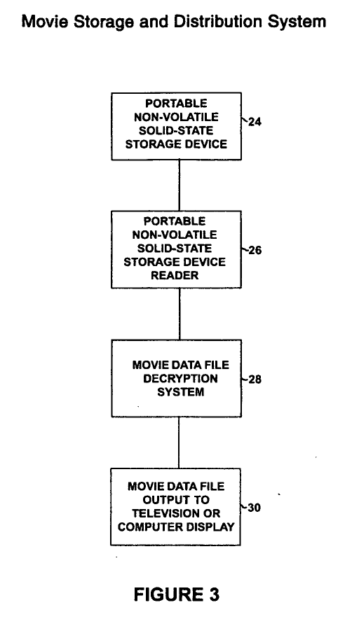

The present invention relates to a method of storing and distributing commercial movies on a portable non-volatile solid-state storage device. The distribution system consisting of a film, video and DVD Movie Compression Computer System and a Movie Database Computer System connected to the Internet, illustrated in more detail in FIG. 1 and FIG. 2. Located at the customer's site is a compatible non-volatile solid-state storage device reader (FIG. 3) facilitating movie playback in real-time on the user's television set or computer system.

1. Audiovisual Compression Computer System

Turning to FIG. 1, a complete motion picture movie is received on a digital videodisc (2), film or video cassette (4) either in conventional analog or digital format. Typically, video output is in real-time at 30 frames per second portraying full motion effects with synchronized stereo audio. The video and audio signals are digitized with separate video and audio analog to digital converters (6 and 8 respectively) and input to the Movie Computer Compressions System (10).

The Movie Compression Computer System (10) consists of a typical personal computer with a DVD-ROM drive, video capture card and special purpose software. The system captures and compresses motion video in real-time and stores the compressed video or Movie Data File (12) on a hard disk.

The Movie Database Computer System (14) must have the capacity to store the required amount of compressed data for the entire duration of the movie, as received from the Movie Compression Computer System (10). Various technologies can be utilized for the. Movie Database Computer System. The following lists several such technologies as well as their present capacities.

| | |
|---|---|
| DVD-ROM | 9 Gigabytes |
| Hard Disks | 10 Terabytes |
| Solid State Memory | 12 Gigabytes |

These technologies can be grouped individually to ensure sufficient storage capacity or a combination of different technologies can be utilized.

2. Movie Database Computer System

Illustrated in FIG. 1 and FIG. 2, the Movie Database Computer System (MDCS) (14) is the storage apparatus for the Movie Data Files (12). It is arranged such that each movie has a unique identification code that is appended to the Movie Data Files (12) when it is initially entered into the Movie Database Computer System (14).

The movie is requested by the customer from a Remote Movie Database Computer System (16), a Kiosk Movie Database Computer System (18) or a Online Movie Database Computer System (20) and after verification of the customer's credit and/or membership card number, confirmation is given to the user and the movie is secured by the Security Encryption System (22) then transferred from the database to the customers portable non-volatile solid-state storage device (24). The Movie Database Computer System (14) also automatically collects statistics (frequently requested movie, time and place of downloads, etc.) and performs all accounting requirements.

Turning to FIG. 3, it is a preferred aspect of the present invention that the customer's portable storage device (24) allows replay on a compatible Portable Non-Volatile Solid-State Storage Device Reader (26) if the Movie Data File Decryption System (28) is detected or the proper security identification is provided to unlocked the Movie Data File (12) which can then be output to the television set or computer system (30).

Thus it is apparent that there has been provided in accordance with the invention a method and apparatus for distribution of movies to a customer that fully satisfies the objects, aims and advantages set forth above. While the invention has been described in conjunction with a specific methodology thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

What we claim as our invention:

1. A method for storing and distributing full-length movies to the customer on a portable non-volatile solid-state storage device in a permanent or non-permanent state, the method comprising the steps of:
(a) Digitizing and compressing the audiovisual data corresponding to an entire movie into a Movie Data File (MDF).
(b) Storing the Movie Data File (MDF) to a Movie Database Computer System (MDCS).
(c) Storing the Movie Data File (MDF) on the portable non-volatile solid-state storage device.
(d) Reading the Movie Data File (MDF) from the portable non-volatile solid-state storage device with a portable non-volatile solid-state storage device reader wherein the portable non-volatile solid-state storage device reader has the means to read and convert the Movie Data File (MDF) to audio and video signals compatible with an output display.

2. A method according to claim 1 wherein the preliminary step to create the Movie Data File (MDF), containing the audiovisual data corresponding to an entire movie, is to digitize and compress the audiovisual data from a film, video cassette, or Digital Video Disc and store the Movie Data File (MDF) to a Movie Database Computer System (MDCS).

3. A method according to claim 1 wherein the Movie Data File (MDF) can be encrypted with a security feature wherein the portable non-volatile solid-state storage device reader has the means to decrypt the Movie Data File (MDF) prior to converting the audiovisual content to audio and video signals compatible with an output display.
